(19) United States
(12) Patent Application Publication
(10) Pub. No.: US 2016/0341870 A1
(43) Pub. Date: Nov. 24, 2016

(54) Liquid Crystal Display Apparatus Having a Narrow Bezel

(71) Applicant: Shenzhen China Star Optoelectronics Technology Co., Ltd., Shenzhen, Guangdong (CN)

(72) Inventors: Chen XIE, Shenzhen, Guangdong (CN); Zhongjie LIU, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/428,364

(22) PCT Filed: Jan. 27, 2015
(86) PCT No.: PCT/CN2015/071610

§ 371 Date: Mar. 14, 2015

(30) Foreign Application Priority Data
Dec. 23, 2014 (CN) 201410814951.2

(51) Int. Cl. F21V 8/00; G02F 1/1335

(52) U.S. Cl. CPC G02B 6/0016; G02B 6/0055; G02B 6/0088; G02F 1/133512; G02F 1/133528

(57) ABSTRACT

The disclosure is related to a liquid crystal display device having a narrow bezel, comprising a display panel, a plastic frame, an optical film set, a light guide plate having a light-blocking area and a reflective sheet. The light-blocking tape is adhered on the plastic frame and extended onto the optical film set. The light-blocking tape and the light-blocking area do not overlap the AA area of the display panel in the width direction. The light-blocking tape and the light-blocking area overlap at least partially in the width direction of the display panel.

### BACKGROUND OF THE INVENTION

1. Field of the Invention

The disclosure relates to a display technology field, and more particularly to a liquid crystal display apparatus having a narrow bezel.

2. The Related Arts

Some manufacturers use “narrow bezel” as a selling point to attract consumers with the technical development of mobile communication products and PAD products. The frame width of the display module is directly related to the bezel width of the display apparatus. In order to ensure some important indicators, e.g. the viewing area, the angle of the field of view, brightness, and the structural stability etc., the usual practices decrease the sidewall thickness of the plastic frame and reduces the width of the sidewall to meet the requirement of a narrow bezel.

In order to achieve the display module having a narrow bezel, the distance between the edge of the active area (AA) of the display panel and the sidewall of the light guide plate and the optical film requires to be substantially reduced. To ensure the brightness requirements of the AA area and the edge of the display panel, the length of the adhesive protruding from the plastic frame into the films is also reduced. The sidewall of the light guide plate is also polished. The light diffuses and reflects repeatedly in the edge region of the light guide plate and illuminates from the light-exiting surface. The brightness of the light illuminating from this part is much higher than the brightness of the light diffusing through the bottom dots of the light guide plate. The present modules having a narrow bezel lack of the effective light blocking manner such that the bright lines occur at the two long edges of the screen. The light leakage is particularly conspicuous when viewing from the side of the display panel. The light leakage influences the displaying effect and the customer experience.

### SUMMARY

In view of the deficiencies existing in the current technology, one embodiment of the disclosure provides a liquid crystal display device having a narrow bezel. The present disclosure not only ensures the light-blocking effect and displaying effect but also prevents light leakage under the premise of a narrow bezel design.

In order to accomplish the above purpose, the disclosure provides the following technical solutions.

In one embodiment, the disclosure provides a liquid crystal display device having a narrow bezel. The liquid crystal display device having a narrow bezel comprises a display panel having an AA area, a plastic frame, an optical film set, a light guide plate having a light-blocking area; and a reflective sheet; wherein the light-blocking tape is adhered on the plastic frame and extended onto the optical film set; the light-blocking tape and the light-blocking area do not overlap the AA area of the display panel in the width direction; the light-blocking tape and the light-blocking area overlap at least partially in the width direction of the display panel.

In one embodiment, the reflective sheet is close to the bottom surface of the plastic frame and the bottom surface of the light guide plate.

In one embodiment, the display panel comprises an upper polarized sheet, a CELL and a lower polarized sheet; wherein the lower polarized sheet is adhered on the upper surface of the plastic frame and close to the upper surface of the light-blocking tape.

In one embodiment, the optical film set is aligned with the edge of the light guide plate.

In one embodiment, the light-blocking area is an inkjet printing structure.

In one embodiment, the light-blocking area is an unpolished structure.

In one embodiment, the light-blocking area extends from the periphery of the light guide plate to the intermediate part of the light guide plate.

In one embodiment, a dot pattern for diffusing light is disposed on the sidewall of the light guide plate.

The disclosure adopts the light-blocking tape and the light-blocking area in the light guide plate surface. The light-blocking area does not overlap the AA area of the display panel in the width direction. The light-blocking tape and the light-blocking area overlap at least partially in the width direction. The disclosure prevents the light leakage influences of the sidewall of the light guide plate without producing the bright lines and increases the displaying effect and the customer experience.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is the schematic diagram of a liquid crystal display apparatus having a narrow bezel of Embodiment 1 according to the disclosure; and

FIG. 2 is the schematic diagram of a liquid crystal display apparatus having a narrow bezel of Embodiment 2 according to the disclosure.

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

### Embodiment 1

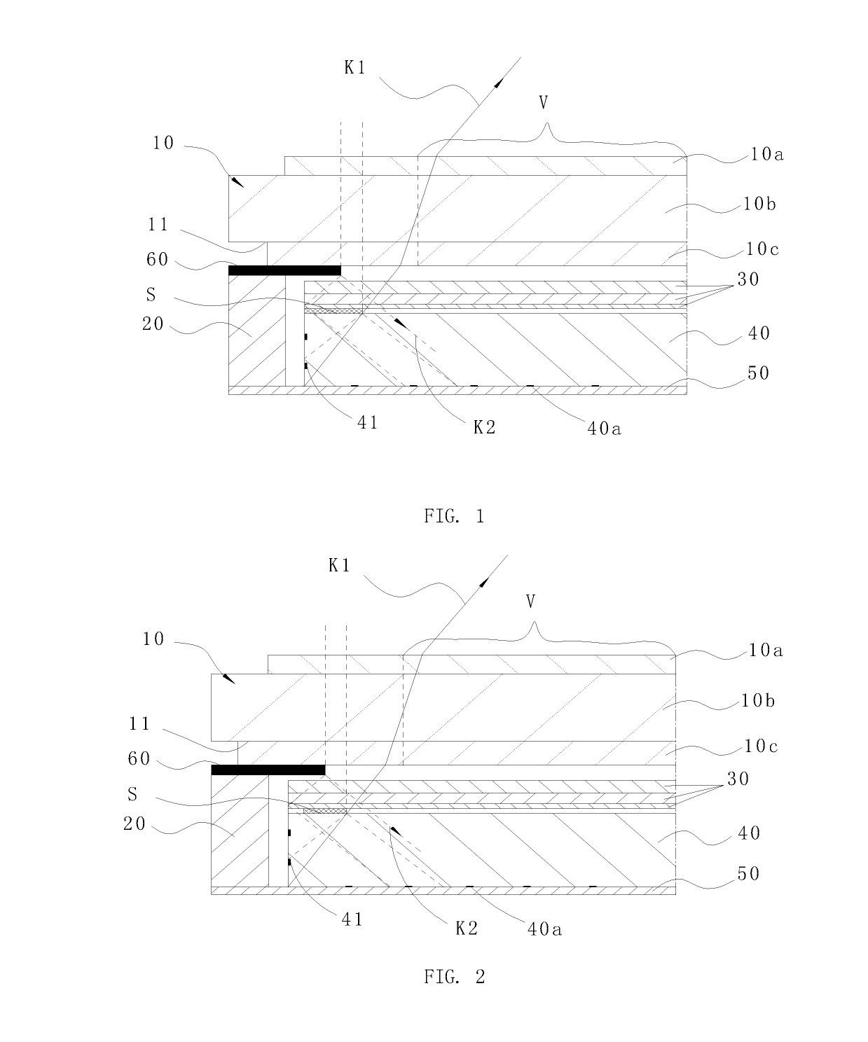

Refer to FIG. 1. The liquid crystal display apparatus having a narrow bezel of the disclosure comprises a display panel 10, a plastic frame 20, an optical film set 30, a light guide plate 40, and a reflective sheet 50. The light-blocking tape 60 is adhered on the plastic frame 20. The light guide plate 40 is provided with a light-blocking area S. The light-blocking tape 60 is extended onto the optical film set 30 and blocks the two side of the light leakage of the display panel 10. The light-blocking tape 60 and the light-blocking area S do not overlap the V of the AA area of the display panel 10 in the width direction. The light-blocking tape 60 and the light-blocking area S overlap at least partially in the width direction of the display panel.

The bottom dots 40a for uniform diffusing and reflecting are deposed on the upper surface of the reflective sheet 50 and close to the bottom surface of the plastic frame 20 and the bottom surface of the light guide plate 40. The optical film set 30 is disposed on the upper surface of the light guide plate 40. The optical film set 30 and the light guide plate 40 are disposed in the enclosed space which is made by plastic frame 20. The lower surface of the display panel 10 is close to the upper surface of the plastic frame 20 and the optical film set 30. The optical film set 30 is a three-layered stack structure. There are the upper prism film, the lower prism film and the diffusion film from top to bottom.

Specifically, the display panel 10 comprises an upper polarized sheet 10a, a CELL 10b and a lower polarized sheet 10c. The lower polarized sheet 10c is used to transform the natural light into the linearly polarized light. The lower polarized sheet 10a is adhered on the upper surface of the plastic frame and close to the upper surface of the light-blocking tape. In this embodiment, the light-blocking tape 60 is a frame paste composed by mixing epoxy resins, catalysts and catalyst solvent. A portion of the light-blocking tape 60 is adhered on the plastic frame 20, and a portion of light-blocking tape 60 extends onto the upper prism film of the optical film set 30. The effects of light blocking, adhering and sealing are achieved simultaneously.

The optical film set 30 is aligned with the edge of the light guide plate 40. The light-blocking area S is an inkjet printing structure or an unpolished structure formed by particles. The edge of the light-blocking area S is aligned with the light guide plate 40. That is the light-blocking area S is distributed at the edge of the light guide plate 40, and extends from the periphery of the light guide plate to the intermediate part of the light guide plate. The light-blocking area S is substantially a “III” shape.

To increase the light diffusing effects of the sidewall of the light guide plate 40 and decrease the light intensity at the periphery of the light guide plate 40, a dot pattern 41 for diffusing light is further disposed on the sidewall of the light guide plate 40.

The first light path K1 ensures the maximum AA area. In the first light path K1, after the light is reflected by the sidewall of the light guide plate 40, the light exits from the light-emitting surface (not shown) of the upper surface of the light guide plate 40 to the display panel 10 and is then refracted. The second light path K2 is the limit light path that a total reflection is formed at the light exiting surface after the light is reflected by the sidewall.

The light leakage easily occurs between the region of the light in the first light path K1 exiting from the optical film set 30 and the region close to the plastic frame 20. To prevent the light leakage at this region, the common overlap width at the width direction of the display panel 10 of the light-blocking area S and the light-blocking tape 60 of the disclosure at least blocks the first light path K1 and the second light path K2. And in the meanwhile, the light-blocking area S and the light-blocking tape 60 do not overlap the AA area of the display panel 10 at the width direction of the display panel 10.

### Embodiment 2

As shown in FIG. 2, the difference between this embodiment and Embodiment 1 is a certain distance exists between the light-blocking area S of the light guide plate 40 and the sidewall of the light guide plate 40. The light-blocking area S does not overlap with the edge of the upper surface of the light guide plate 40. The light blocking tape 60 and the light-blocking area S merely overlap partially in the width direction of the display panel 10.

The disclosure adopts the light-blocking tape 60 adhered on the plastic frame 20. The light-blocking area S is disposed on the upper surface of the light guide plate 40. The light-blocking area S does not overlap the AA area of the display panel in the width direction such that decrease of the AA area is prevented. The light-blocking tape 60 and the light-blocking area S overlap at least partially in the width direction of the display panel 10 to prevent the light leakage from occurring at the light-blocking tape 60 and the light-blocking area S.

The disclosure adopts the light-blocking tape 60 at the plastic frame 20 and the light-blocking area S of the light guide plate 40 to commonly overlap the light leakage region at the two sides of the light-exiting surface of the light guide plate 40 to ensure the maximum AA area of the display panel 10. The light leakage at the sidewall of the light guide plate is well prevented, and the bright lines at the two sides of the display panel are also prevented. The display effects and the consumer experience are increased.

Although the present disclosure is illustrated and described with reference to specific embodiments, those skilled in the art will understand that many variations and modifications are readily attainable without departing from the spirit and scope. Such variations and modifications should also be regarded as the protection of the disclosure.

What is claimed is:

1. A liquid crystal display device having a narrow bezel, comprising:
a display panel having an AA area;
a plastic frame;
an optical film set;
a light guide plate having a light-blocking area; and
a reflective sheet;
wherein the light-blocking tape is adhered on the plastic frame and extended onto the optical film set; the light-blocking tape and the light-blocking area do not overlap the AA area of the display panel in the width direction; the light-blocking tape and the light-blocking area overlap at least partially in the width direction of the display panel.

2. The liquid crystal display device having a narrow bezel according to claim 1, wherein the reflective sheet is close to a bottom surface of the plastic frame and a bottom surface of the light guide plate.

3. The liquid crystal display device having a narrow bezel according to claim 1, the display panel comprising an upper polarized sheet, a CELL and a lower polarized sheet; wherein the lower polarized sheet is adhered on the upper surface of the plastic frame and close to the upper surface of the light-blocking tape.

4. The liquid crystal display device having a narrow bezel according to claim 1, wherein the optical film set is aligned with the edge of the light guide plate.

5. The liquid crystal display device having a narrow bezel according to claim 1, wherein the light-blocking area is an inkjet printing structure.

6. The liquid crystal display device having a narrow bezel according to claim 1, wherein the light-blocking area is an unpolished structure.

7. The liquid crystal display device having a narrow bezel according to claim 1, wherein the light-blocking area extends from the periphery of the light guide plate to the intermediate part of the light guide plate.

8. The liquid crystal display device having a narrow bezel according to claim 7, wherein a dot pattern for diffusing light is disposed on the sidewall of the light guide plate.

9. The liquid crystal display device having a narrow bezel according to claim 2, wherein the light-blocking area extends from the periphery of the light guide plate to the intermediate part of the light guide plate.

10. The liquid crystal display device having a narrow bezel according to claim 9, wherein a dot pattern for defusing light is deposed on a sidewall of the light guide plate.

11. The liquid crystal display device having a narrow bezel according to claim 3, wherein the light-blocking area extends from the periphery of the light guide plate to the intermediate part of the light guide plate.

12. The liquid crystal display device having a narrow bezel according to claim 11, wherein a dot pattern for defusing light is deposed on a sidewall of the light guide plate.

13. The liquid crystal display device having a narrow bezel according to claim 4, wherein the light-blocking area extends from the periphery of the light guide plate to the intermediate part of the light guide plate.

14. The liquid crystal display device having a narrow bezel according to claim 13, wherein a dot pattern for defusing light is deposed on a sidewall of the light guide plate.

15. The liquid crystal display device having a narrow bezel according to claim 5, wherein the light-blocking area extends from the periphery of the light guide plate to the intermediate part of the light guide plate.

16. The liquid crystal display device having a narrow bezel according to claim 15, wherein a dot pattern for defusing light is deposed on a sidewall of the light guide plate.

17. The liquid crystal display device having a narrow bezel according to claim 6, wherein the light-blocking area extends from the periphery of the light guide plate to the intermediate part of the light guide plate.

18. The liquid crystal display device having a narrow bezel according to claim 17, wherein a dot pattern for diffusing light is disposed on the sidewall of the light guide plate.
